(19) United States
(12) Patent Application Publication
(10) Pub. No.: US 2014/0347162 A1
(43) Pub. Date: Nov. 27, 2014

(54) AUTOMATIC DOOR SYSTEM HAVING A SECURITY SENSOR DEVICE AND METHOD FOR USING SAID SYSTEM

(71) Applicant: JCM TECHNOLOGIES, S.A., VIC (BARCELONA) (ES)

(72) Inventors: Ricard Renalias Zueras, Manresa (Barcelona) (ES); Jordi Beringues Algue, Girona (ES)

(73) Assignee: JCM TECHNOLOGIES, S.A., VIC (BARCELONA) (ES)

(21) Appl. No.: 14/236,324

(22) PCT Filed: Oct. 26, 2012
(86) PCT No.: PCT/ES2012/070751

§ 371 Date: Jan. 30, 2014

(30) Foreign Application Priority Data
Feb. 14, 2012 (ES) 201230231

(51) Int. Cl. G07C 9/00

(52) U.S. Cl. CPC G07C 9/00111
USPC 340/5.71

(57) ABSTRACT

The invention relates to an automatic door system having a security sensor device and to a method for using said system, in which a controller is connected to a security sensor, the sensor device comprising: a signal emitter for detecting at least one parameter representative of the door; and a receptor of the signal generated by the generator; wherein the controller activates at least the emitter by means of a triggering signal, said triggering signal being a signal independent of the signal to be emitted by the emitter.

The present invention relates to an automatic door control system, for example for garages, having a safety strip for detecting collisions during the operation of the door, and also a method for controlling a door comprising a safety strip.

Official regulations on garage doors limit the force exerted by the automatic door in the event of collision with an object or person, to prevent that object or person from being trapped.

To achieve effective limitation of force, a pressure sensor mechanism, known as a “safety strip” is placed on at least one of the ends of the moveable parts of the door. These safety strip(s) have to be connected to the control panel, to inform the system of the occurrence of collisions.

There are many known mechanisms for detecting obstacles for automatic doors, for example, using the emission of an infrared beam; however, these mechanisms are characterised by their high power consumption.

For example, document US 2006/0204206 discloses a method in which an infrared emitter produces a signal, said signal is detected by a receiver and, once this signal is received, a signal is fed back to the emitter in order for it to send another signal. In this way the emitter can check that the signal sent matches the signal received and does not correspond to interference. Moreover, this feedback signal can also function as a signal for calibrating the power of the infrared beam.

This implementation permits a diagnostic capability, since the receiver can distinguish whether the failure to receive infrared beams is due to a signal emission fault (for example, the battery having run down) or because a collision has occurred.

Nonetheless, the type of system proposed in that document has the drawback that signals have to be generated constantly, to allow status verification, which proves particularly inefficient in applications in which both the emitter and the receiver have a power supply, for example, using batteries. Consequently, it proves very advantageous to have a system offering a fault diagnosis capability, as a safety feature to determine when a collision at the door or a fault has occurred, and also having a standby state that allows the power consumption of the aforementioned system to be reduced.

Therefore, the present invention relates to an automatic door system having a safety strip for a door provided with a motor and a control panel associated with said motor, comprising:
a stationary wireless signal receiver connected to the control panel;
at least one sensor device located at the moveable end of the door;
at least one controller for the sensor device, communicating wirelessly with the stationary receiver;
   wherein the sensor device comprises:
a signal emitter; and
a receiver for the signal generated by the emitter for detecting at least one representative parameter of the door;
   wherein the controller activates at least the emitter via a trigger signal, said trigger signal being a signal independent from the signal to be transmitted by the emitter. In one particular embodiment, both the emitter and the receiver are connected to the controller, and said sensor device is a safety strip.

In another particular embodiment, the trigger signal is generated periodically at configurable time intervals, and the controller is located outside the sensor device, forming part of a different device.

Preferably, the controller activates at least the emitter via the trigger signal. In particular embodiments, this activation involves changing from a standby mode to a normal power consumption mode. In other embodiments, the electrical power for the emitter and/or receiver comes from the controller.

More preferably, the emitter is a generator of a polarised light beam, for example an infrared light beam.

Even more preferably, the controller comprises a radio-frequency emitter operating in the ISM band, particularly in the 870 MHz frequency.

On the other side, both the receivers and the RF emitters described in the present invention could be transceivers and have bidirectional communication among themselves.

In a particular embodiment, both the sensor device and the controller are supplied with power by batteries.

In addition, the present invention also relates to a method for operating an automatic door system having a safety strip for a door provided with a motor and a control panel associated with said motor, said automatic door system comprising:
a stationary wireless signal receiver connected to the control panel;
at least one sensor device located at the moveable end of the door;
at least one controller for the sensor device, communicating wirelessly with the stationary receiver;
   wherein the sensor device comprises:
a signal emitter; and
a receiver for the signal generated by the emitter for detecting at least one representative parameter of the door;
   comprising the steps of

a)emission of a signal by the emitter to the receiver;

b)detection and analysis of the signal received by the receiver; and

c)emission of a signal from the sensor device as a function of the signal received by the receiver;

wherein, before step a), the controller sends a trigger signal to the emitter causing the emitter to send a signal to the receiver for detecting collisions.

Preferably, the method according to the present invention comprises a step d) wherein the receiver feeds the signal received from the emitter back to the controller.

More preferably, the method comprises a step e) wherein, if the controller does not receive the feedback signal, it sends a fault signal.

In one particular embodiment the trigger signal is a periodic signal, although it could be an external signal sent to the controller to cause said controller to activate the emitter.

Moreover, the controller can feature a signal that controls the switching on/off of the emitter and/or the receiver.

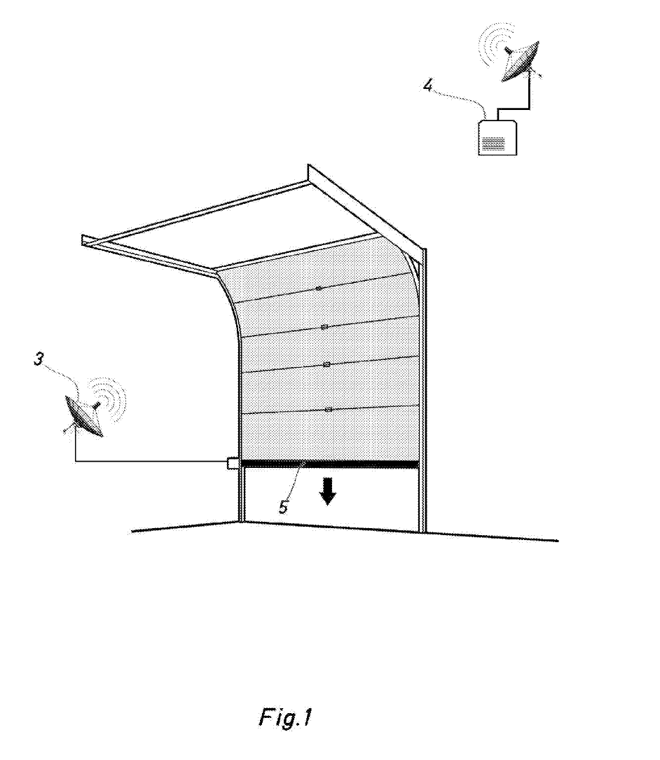

FIG. 1 shows a diagrammatic view of a system according to the present invention.

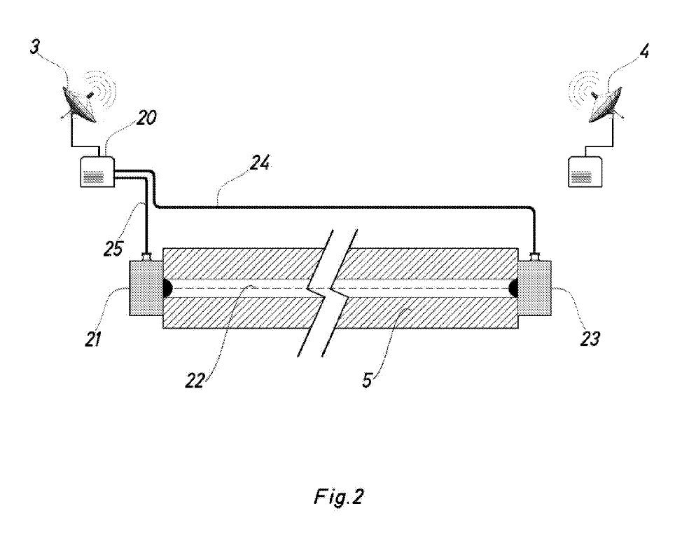

FIG. 2 shows in detail the devices forming part of an embodiment according to the present invention and the connections between them when there is no obstacle located at the door.

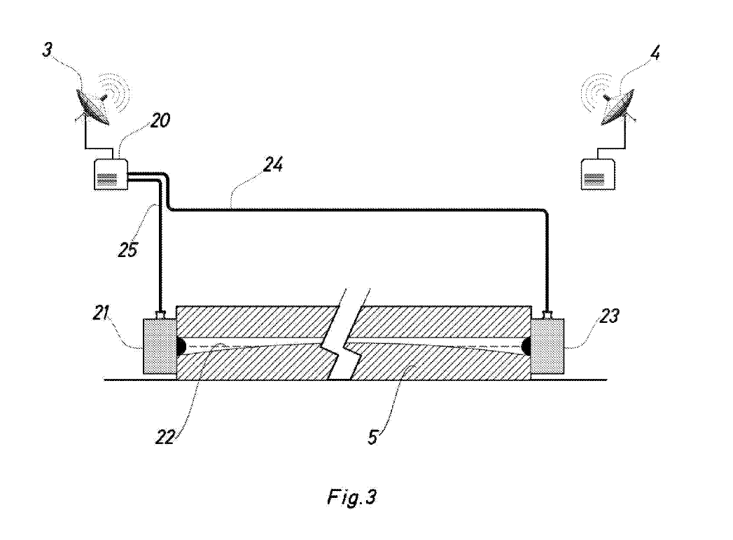

FIG. 3 shows in detail the devices forming part of an embodiment according to the present invention and the connections between them when an obstacle is encountered while the door is moving.

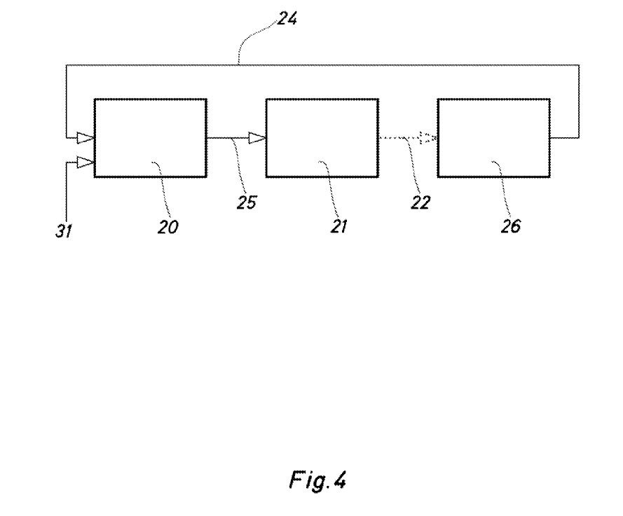

FIG. 4 shows a block diagram explaining the operation of the sensor device.

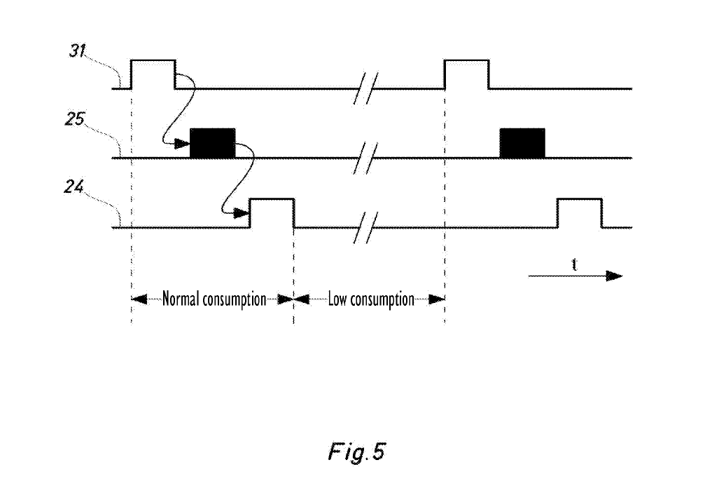

FIG. 5 shows diagrammatically the operating modes of each device.

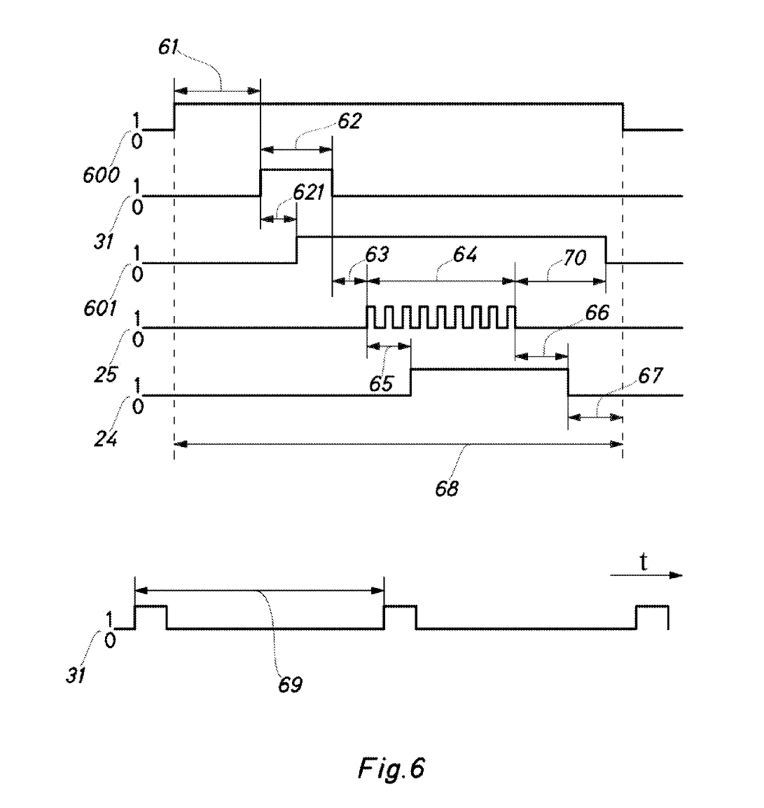

FIG. 6 shows in detail the digital signals used by a system according to the present invention.

FIG. 1 shows diagrammatically a device according to the present invention.

This figure shows a radio-frequency transceiver (3), comprising a controller (not shown), a sensor device (5) and a stationary radio-frequency receiver device (4), (which, in one particular embodiment, is a radio-frequency transceiver). Moreover, in this embodiment, collisions are detected at the door by means of the sensor device (5), which can be a strip that makes a digital measurement indicating whether or not the door is being blocked by an obstacle.

Alternatively, the sensor device (5) can be a strip that makes an analogue measurement of the force exerted on the door.

FIGS. 2 and 3 show the radio-frequency transceiver device (3) connected to a controller (20), the radio-frequency receiver device (4) and, in greater detail, the sensor device (5).

The sensor device (5) comprises a generator, which in this particular case is an infrared light generator (21), a detector (23) of the emitted infrared light, and a rubber strip along which longitudinal opening the infrared light beam (22) passes. The collision detection method in the door of this particular embodiment works by sending a beam of infrared light along the strip (5). When the door collides with an obstacle the strip (5) is deformed (see FIG. 3), preventing the light from passing between the generator and the detector. In this way it is detected if the door is exerting a force against an obstacle or if it can continue moving.

In the present invention, the output signal from the sensor device is fed back, permitting greater diagnostic capability, since what generally happens in conventional devices is that a fault in the generator can be erroneously interpreted as a collision. For this purpose, a connection (25) is made between the controller (20) and the emitter (21) and there is feedback (24) between the receiver (23) and the controller (20), which compares whether the signal sent by the emitter (21) is the one received by the receiver (23), identifying whether it is a signal caused by deformation of the strip (5) or a signal produced by some fault in the sensor device.

Based on the result of this comparison, the control panel identifies whether to actuate the motor to continue closing the door, whether to stop it because a collision has taken place or whether a fault has occurred in the system. In particular embodiments of the present invention, the communication between the stationary receiver (4) and the radio-frequency transceiver (3) can be bidirectional.

FIG. 4 shows diagrammatically the internal behaviour of the sensor device. This figure illustrates the communication between the controller (20), the emitter (21) via a connection (25) and also a connection between the emitter (21) and the receiver (26) via a beam of infrared light (22) and the feedback (24) of data obtained to the controller (20) for subsequent analysis.

Another important aspect of the present invention is the ability to improve the energy efficiency of the system, since it permits to have a trigger signal (31) to indicate to the controller when it must have the emitter (20) to send a signal. In a preferred embodiment of the present invention the triggering takes place at a constant frequency, although this could depend on external factors such as an RF signal coming from a stationary radio-frequency emitter (not shown).

Preferably, in addition to the signals for signal emission, triggering, and notification of receipt of signal by the receiver, the controller can incorporate power supply connections both to the emitter and the receiver, switching off the devices when there is no trigger signal and, once this signal is received, activating the devices; later, when the signal has already been sent by the receiver it switches them off again.

FIG. 5 shows diagrammatically the signals produced in the device, showing which signals are generated in the device when it is activated via a trigger signal (31).

As shown in the figure, a pulse is provided as a trigger signal (31) that sends to the emitter, via a connection (25), a signal that said emitter sends to the receiver, in this particular case, via infrared light beams. Once the receiver receives this signal, it feeds it back to the controller via a connection (24) so that said controller can analyse the signal received and identify whether said signal indicates that the door has collided, whether the process is ongoing, or whether it is due to a fault in one of the devices comprised in the system.

FIG. 6 shows, as a whole, the signals between some of the devices in one embodiment of the present invention.

The signal (600) refers to the power consumption of the system; it can be seen that there is a time interval (61) between the moment when the controller decides to start sending a signal and when the trigger signal (31) is generated. In the preferred embodiment described in FIG. 6, the trigger signal is a pulse signal with a given actuation time (62).

After the emission of the pulse, which works as a trigger signal, some time (621) passes until the signal reaches the emitter, which changes its status from passive mode (low power consumption) to active mode (normal power consumption).

Subsequently, some time (63) after the emitter changes from passive to active mode, a signal (25) is sent, in this particular example an infrared signal, for a given time (64); once this signal is sent and some time (70) later, the emitter returns to passive mode.

This signal (25) can be a constant signal or a series of pulses, as indicated in the figure.

Furthermore, the receiver receives the signal (24) sent by the emitter with a time lag (65), (66) afterwards, and sends this signal as feedback; once this feedback reaches the controller again, i.e. some time (67) later, the system returns to a low power-consumption mode, or passive mode.

As indicated in previous sections, in the present invention the trigger signal can be a signal defined by means of other devices forming part of the system or can be a signal generated repetitively with a time period (69).

Although the invention has been described in relation to preferred exemplary embodiments, these should not be considered to restrict the invention, which is to be defined by the broadest interpretation of the following claims.

1. Automatic door system having a safety sensor device for a door provided with a motor and a control panel associated with said motor, comprising:
a stationary wireless signal receiver connected to the control panel;
at least one sensor device located at the moveable end of the door;
at least one controller for the sensor device, communicating wirelessly with the stationary receiver;
the sensor device comprising:
an optical signal emitter; and
a receiver for the optical signal generated by the emitter characterised in that the controller activates at least the emitter via a trigger signal, said trigger signal being a signal independent from the signal to be emitted by the emitter.

2. System according to claim 1, wherein the sensor device is a safety strip.

3. System according to claim 1 wherein the controller is provided outside the sensor device.

4. System according to claim 1 wherein both the emitter and the receiver are connected to the controller.

5. System according to claim 1 wherein t the trigger signal is generated periodically at configurable time intervals.

6. System according to claim 1 wherein the controller activates the receiver via the trigger signal.

7. System according to claim 1 wherein the electrical supply to the emitter comes from the controller.

8. System according to claim 1 wherein the electrical supply to the receiver comes from the controller.

9. System according to claim 1 wherein the emitter is a generator of a polarised light beam.

10. System according to claim 9, wherein the polarised light beam is an infrared light beam.

11. System according to claim 1 wherein the controller comprises a radio-frequency emitter operating in the ISM band.

12. System according to claim 11, wherein the radio-frequency emitter operates in the 870 MHz frequency.

13. System according to claim 1 wherein both the sensor device and the controller are supplied with power by batteries.

14. System according to claim 1 wherein both the stationary wireless signal receiver and the controller comprise transceivers.

15. Method for operating an automatic door system having a safety sensor device for a door provided with a motor and a control panel associated with said motor, said automatic door system comprising:
a stationary wireless signal receiver connected to the control panel;
at least one sensor device located at the moveable end of the door;
at least one controller for the sensor device, communicating wirelessly with the stationary receiver;
the sensor device comprising:
an optical signal emitter; and
a receiver for the optical signal generated by the emitter;
comprising the steps of
a) emission of a signal by the emitter to the receiver;
b) detection of the signal received by the receiver; and
c) emission of a signal from the sensor device according to the signal received by the receiver;
characterised in that, before step a), the controller sends a trigger signal to the emitter causing the emitter to send a signal to the receiver for detecting collisions.

16. Method according to claim 15, further comprising a step d) in which the receiver feeds the signal received from the emitter back to the controller.

17. Method according to claim 16, further comprising a step e) in which, if the controller does not receive the feedback signal, it sends a fault signal.

18. Method according to claim 15, wherein the trigger signal is a periodic signal.

19. Method according to claim 15, wherein the controller sends the trigger signal after receiving a signal from outside.

20. Method according to claim 15, wherein the controller has a signal that controls the switching on/off of at least the emitter.

21. Method according to claim 15, wherein the controller has a signal that controls the switching on/off of the receiver.
